(19) United States
(12) Patent Application Publication
(10) Pub. No.: US 2025/0231433 A1
(43) Pub. Date: Jul. 17, 2025

(54) QUANTUM ENTANGLEMENT GENERATOR USING CONTINUOUS WAVE LASER

(71) Applicant: GWANGJU INSTITUTE OF SCIENCE AND TECHNOLOGY, Gwangju (KR)

(72) Inventor: Byoung Seung HAM, Gwangju (KR)

(21) Appl. No.: 18/796,601

(22) Filed: Aug. 7, 2024

(30) Foreign Application Priority Data
Jan. 11, 2024 (KR) 10-2024-0004903

(51) Int. Cl. G02F 1/01; G02F 1/11; G02F 1/21

(52) U.S. Cl. CPC G02F 1/0136; G02F 1/11; G02F 1/212

(57) ABSTRACT

The present disclosure provides a continuous-wavelength quantum entanglement laser generator including: an orthogonally polarized continuous wavelength laser light source; a polarization-path correlation Mach-Zehnder interferometer for controlling the polarization base of the orthogonally polarized continuous wavelength laser light source; a pair of frequency-path correlation Mach-Zehnder interferometers for generating a frequency-path correlation entangled light pair using two outputs of the polarization-path correlation Mach-Zehnder interferometer as input sources; and a pair of quantum erasers for converting frequency-distinguishable light output from the pair of frequency-path correlation Mach-Zehnder interferometers into indistinguishable entangled light.

### CROSS-REFERENCE TO RELATED APPLICATIONS

This application claims benefit and priority to Korean Patent Application No. 10-2024-0004903, filed on Jan. 11, 2024, with the Korean Intellectual Property Office, the disclosure of which is incorporated herein in its entirety by reference.

### TECHNICAL FIELD

The present disclosure relates to a quantum entanglement generator using a continuous wavelength laser, and more particularly to a quantum entanglement laser generator using a Mach-Zehnder interferometer (MZI) based on linear optics.

### BACKGROUND

The content described in this section merely provides background information related to one embodiment of the present disclosure and does not constitute prior art.

All quantum light source generation methods based on nonlinear optics have generated conventional quantum light sources based on, for example, spontaneous parametric down-conversion (SPDC), a second-order nonlinear optical phenomenon, or generation of entangled photon pairs through light splitting and π phase conversion or nonlinear squeezed light.

The core of the Copenhagen interpretation in the early days of quantum mechanics in the 1920s concerns the uncertainty principle and quantum superposition in the mechanical analysis of single photons, spins, atoms, or electrons.

The uncertainty principle is one of the key quantum phenomena appearing at the single particle level and relates to the microscopic dynamics interpretation that it is impossible to measure the conjugate variables that make up the particle, for example, position and momentum, or frequency and time, very accurately at the same time, and the more accurately one is measured, the less accurately the other is measured proportionally. However, the uncertainty principle does not apply in cases where two or more different particles have a quantum correlation.

For example, according to the EPR paper, which became a key debate by Einstein and co-authors in 1935, when a neutral spin pair whose original spin sum is 0 (zero) separates at some point and proceeds in opposite directions, in order to satisfy the law of conservation of momentum, if one of the spin pair is the up state, the other must be in the down state. In this case, for the spin pair at the initial 0 position, the individual spin state has a complementary relationship between position and momentum, so it is impossible to accurately predict the momentum, that is, the spin state, satisfying the uncertainty principle of quantum mechanics. Therefore, while each spin state in the initial spin pair is random, the sum of position and momentum is always accurately predictable after the spin pair is separated. In other words, the basis of the EPR debate is that individual particles must satisfy the uncertainty principle, but particle (spin) pairs do not need to satisfy the uncertainty principle.

For such particle pairs, since Bell published Bell's inequality refuting EPR's hidden variable theory in 1964, quantum correlation in quantum information science has developed into “non-local quantum correlation” that denies the locality of classical mechanics.

Meanwhile, in the case of continuous light sources, it has been developed under the name of squeezed light based on nonlinear optics, where the amplitude and phase of squeezed light have a conjugate variable relationship like individual particles and satisfy the uncertainty principle.

### SUMMARY

In view of the above, the present disclosure provides a quantum entanglement laser generator using coherence optics within a linear optical structure as a light source of a conventional laser based on the wave nature of quantum mechanics, unlike the existing principles and applications of quantum mechanics based on particle nature.

However, the objects to be achieved by the present disclosure are not limited to the objects mentioned above, and other objects may exist.

A continuous-wavelength quantum entanglement laser generator, in accordance with one embodiment of the present disclosure, comprises: an orthogonally polarized continuous wavelength laser light source; a polarization-path correlation Mach-Zehnder interferometer for controlling the polarization base of the orthogonally polarized continuous wavelength laser light source; a pair of frequency-path correlation Mach-Zehnder interferometers for generating a frequency-path correlation entangled light pair using two outputs of the polarization-path correlation Mach-Zehnder interferometer as input sources; and a pair of quantum erasers for converting frequency-distinguishable light output from the pair of frequency-path correlation Mach-Zehnder interferometers into indistinguishable entangled light.

Preferably, the continuous-wavelength quantum entanglement laser generator further comprises a Mach-Zehnder phase control unit that controls a phase of the polarization-path correlation Mach-Zehnder interferometer.

Preferably, the orthogonally polarized continuous-wavelength laser light source further includes a first half-wave plate H1 that rotates a vertically or horizontally polarized continuous-wavelength laser at 22.5 degrees.

Preferably, the polarization-path correlation Mach-Zehnder interferometer includes: a first polarizing beam splitter PBS1 that receives an orthogonally polarized continuous-wavelength laser light, reflects the orthogonally polarized continuous-wavelength laser as vertically polarized light to be output to a first Mach-Zehnder path, and transmits the orthogonally polarized continuous-wavelength laser as horizontally polarized light to be output to a second Mach-Zehnder path; a first electro-optical modulator EOM1 located in the first Mach-Zehnder path; a second electro-optical modulator EOM2 located in the second Mach-Zehnder path; a second half-wave plate H2 that rotates light output from the second electro-optical modulator by 45 degrees; and a second polarizing beam splitter PBS2 that reflects a portion of each vertically or horizontally polarized light traveling on the first Mach-Zehnder path and output from the second half-wave plate and traveling on the second Mach-Zehnder path and transmits the remaining portion to be output to two paths.

Preferably, the polarization-path correlation Mach-Zehnder interferometer further includes a first mirror M1 that reflects light traveling on the first Mach-Zehnder path and a second mirror M2 that reflects light traveling on the second Mach-Zehnder path.

Preferably, each of the pair of frequency-path correlation Mach-Zehnder interferometers includes: a third polarizing beam splitter PBS3 that receives light output from the second polarizing beam splitter PBS2, reflects the vertically polarized light to be output to a third Mach-Zehnder path, and transmits the horizontally polarized light to be output to a fourth Mach-Zehnder path; a first acousto-optic modulator AOM1 located in the third Mach-Zehnder path; a second acousto-optic modulator AOM2 located in the fourth Mach-Zehnder path; and a non-polarizing beam splitter BS that reflects and transmits half of the vertically and horizontally polarized light traveling on the third Mach-Zehnder path and the fourth Mach-Zehnder path to be output to two paths.

Preferably, each of the pair of frequency-path correlation Mach-Zehnder interferometers further includes a third mirror M3 that reflects light traveling on the third Mach-Zehnder path and a fourth mirror M4 that reflects light traveling on the fourth Mach-Zehnder path.

Preferably, the fourth Mach-Zehnder path has a greater length than the third Mach-Zehnder path.

Preferably, one of the pair of quantum erasers includes a first polarizer P1 on Eₛ₁ path, a first detector D1 for detecting light output from the first polarizer P1, a second polarizer P2 on Eₛ₂ path, and a second detector for detecting light output from the second polarizer.

Preferably, the other one of the pair of quantum erasers includes another first polarizer P1 on Eᵢ₃ path, a third detector D3 for detecting light output from the another first polarizer P1, another second polarizer P2 on Eᵢ₄ path, and a fourth detector D4 for detecting light output from the another second polarizer P2.

According to the above-described embodiment of the present disclosure, the present disclosure can provide a continuous-wavelength quantum laser generation method and apparatus that satisfies non-classical quantum correlation, that is, violation of Bell inequality, by stochastically generating indistinguishable photon pair polarization bases from an indistinguishable coherent light source at the same rate, which is a completely different method from the principle of generating stochastic entangled photon pairs by spontaneous parametric down-conversion (SPDC) based on existing nonlinear optics.

### BRIEF DESCRIPTION OF THE DRAWINGS

FIG. 1 is a block diagram showing a quantum entanglement generator using a continuous wavelength laser according to one embodiment of the present disclosure.

FIG. 2 is a configuration diagram showing the quantum entanglement generator using the continuous wavelength laser according to one embodiment of the present disclosure.

FIG. 3 is a diagram showing a light pulse output from a wavelength-path correlation Mach-Zehnder interferometer and a light pulse output from a pair of frequency-path correlation Mach-Zehnder interferometers.

FIG. 4 is a graph showing the results of computational simulation of the final output light of a quantum eraser according to the present disclosure.

FIG. 5 shows the results of computational simulation of the local (classical) classical correlation between the final output lights of the quantum eraser according to the present disclosure.

FIG. 6A is a non-local (quantum) quantum correlation computational simulation showing the product of the light output from one of the pair of quantum erasers and the light output from the other of the pair of quantum erasers, and FIG. 6B is a graph showing the intensity of the product of the light output from one of the pair of quantum erasers and the light output from the other of the pair of quantum erasers.

### DETAILED DESCRIPTION

Hereinafter, with reference to the accompanying drawings, embodiments of the present disclosure will be described in detail so that one of ordinary skill in the art to which the present disclosure pertains can easily implement the present disclosure. However, the present disclosure may be implemented in many different forms and is not limited to the embodiments described herein. In order to clearly illustrate the present disclosure in the drawings, parts unrelated to the description are omitted.

Throughout the present specification, when it is described that a part is “connected” to another part, this includes not only cases where the parts are “directly connected,” but also cases where they are “electrically connected” with another element therebetween. In addition, when it is described that a part “includes or comprises” a certain component, this does not mean excluding other components unless specifically stated to the contrary, but may further include other components, and it should be understood that it does not exclude in advance the presence or addition of one or more other features, numbers, steps, operations, components, parts, or combinations thereof.

The following embodiments are described in detail to aid understanding of the present disclosure and do not limit the scope of the present disclosure. Therefore, inventions of the same scope and performing the same function as the present disclosure will also fall within the scope of the present disclosure.

Hereinafter, unlike the conventional quantum mechanical theory based on the particle nature of photons known so far, by generating a “continuous wavelength quantum entanglement laser” based on macroscopic light pulse entanglement pairs satisfying quantum correlation using the wave nature of photons, identifying the principle through quantum correlation measurements, newly establishing the concept of macroscopic quantum correlation based on this, and mathematically proving the violation of Bell's inequality, a quantum entanglement generator using a continuous light source, according to the present disclosure, which generates non-classical light pulse pairs with typical laser-level energy (or intensity) that are identical to the characteristics of nonlinear medium-based single photon pairs, e.g., non-classical entangled photon pairs generated by spontaneous parametric down-conversion (SPDC), will now be described with reference to the drawings.

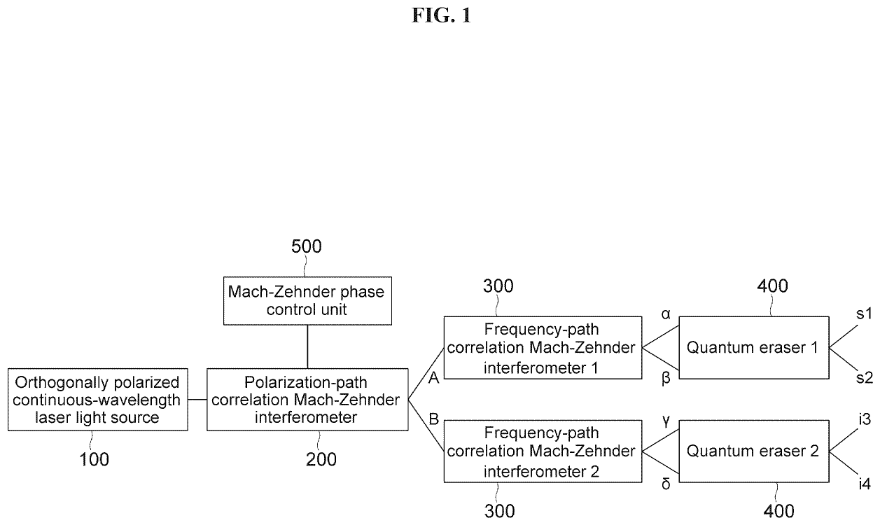

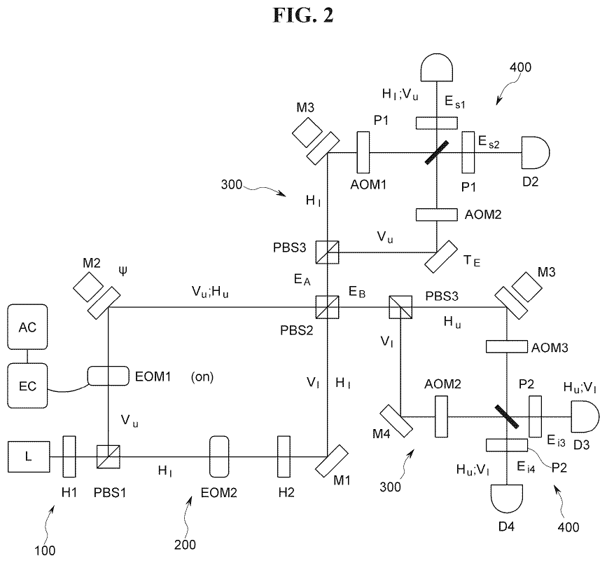

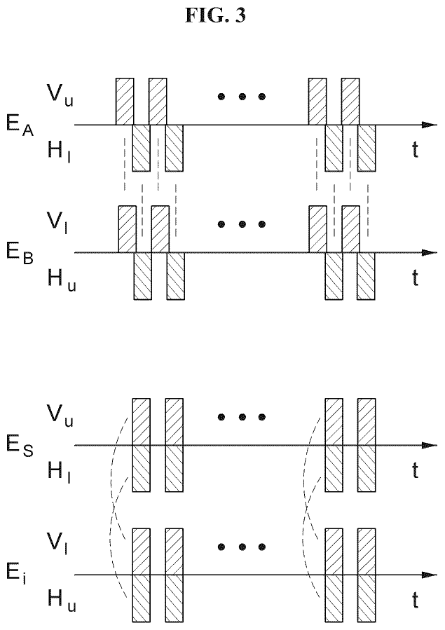

FIG. 1 is a block diagram showing a quantum entanglement generator using a continuous wavelength laser according to one embodiment of the present disclosure. FIG. 2 is a configuration diagram showing the quantum entanglement generator using the continuous wavelength laser according to one embodiment of the present disclosure. FIG. 3 is a diagram showing a light pulse output from a wavelength-path correlation Mach-Zehnder interferometer and a light pulse output from a pair of frequency-path correlation Mach-Zehnder interferometers.

Referring to FIG. 1, the continuous-wavelength quantum entanglement laser generator according to one embodiment of the present disclosure includes: an orthogonally polarized continuous-wavelength laser light source 100; a polarization-path correlation Mach-Zehnder interferometer 200 for regulating a polarization base of the orthogonally polarized continuous wavelength laser light source 100; a pair of frequency-path correlation Mach-Zehnder interferometers 300 for generating frequency-path correlation entangled light pairs using two outputs of the polarization-path correlation Mach-Zehnder interferometer 200 as input sources; and a pair of quantum erasers 400 for converting frequency-distinguishable light output from the frequency-path correlation Mach-Zehnder interferometer 300 into indistinguishable entangled light.

In addition, the continuous-wavelength quantum entanglement laser generator according to one embodiment of the present disclosure may further include a Mach-Zehnder phase control unit 500 that controls the phase of the polarization-path correlation Mach-Zehnder interferometer 200.

The Mach-Zehnder phase control unit 500 may be a piezoelectric device, and may be made of, for example, PZT [Pb(Zr,Ti)O₃].

Meanwhile, referring to FIG. 2, AC represents an AOM (acousto-optical modulator) controller, and EC represents an EOM (electro-optical modulator) controller. The AOM controller and the EOM controller control the electro-optical modulator of the polarization-path correlation Mach-Zehnder interferometer 200 and the acousto-optical modulator (AOM) of the frequency-path correlation Mach-Zehnder interferometer 300, respectively.

Referring to FIG. 2, the orthogonally polarized continuous-wavelength laser light source 100 further includes a first half-wave plate (HWP) H1 that rotates a conventionally vertically or horizontally polarized continuous-wavelength laser by 22.5 degrees to generate an orthogonally polarized based state.

Referring to FIGS. 1 and 2, the orthogonally polarized continuous wavelength laser light source 100 generates vertical or horizontal polarization in equal proportions at the single photon level, and generates vertical or horizontal polarization with equal intensity at the continuous wave level at any given time.

Since the first half-wave plate H1 has an optical axis rotated by 22.5 degrees from the (vertical or horizontal) linear polarization axis of the laser light output from the laser light source 100, the laser light output from the laser light source 100 is converted to 45 degrees, i.e., diagonal linear polarization when transmitted through the first half-wave plate H1. In this case, the diagonal linear polarization is split into the sum of vertical and horizontal polarization, which satisfies the purpose of making the polarization base of the laser random on a first Mach-Zehnder path and a second Mach-Zehnder path.

The polarization-path correlation Mach-Zehnder interferometer 200 includes a first polarizing beam splitter PBS1 that receives an orthogonally polarized continuous-wavelength laser light, reflects it as vertically polarized light, outputs it to the first Mach-Zehnder path, and transmits it as horizontally polarized light to output the second Mach-Zehnder path, a first electro-optical modulator EOM1 located in the first Mach-Zehnder path, a second electro-optical modulator EOM2 located in the second Mach-Zehnder path, a second half-wave plate H2 that rotates the light output from the second electro-optical modulator EOM2 by 45 degrees, and a second polarizing beam splitter PBS2 that reflects a portion of each vertically (or horizontally) polarized light traveling on the first Mach-Zehnder path and output from the second half-wave plate and traveling on the second Mach-Zehnder path and transmits the remaining portion to output it to two paths.

Preferably, the polarization-path correlation Mach-Zehnder interferometer 200 may further include a first mirror M1 that reflects light traveling on the first Mach-Zehnder path and a second mirror M2 that reflects light traveling on the second Mach-Zehnder path.

The first polarizing beam splitter PBS1 receives an orthogonally polarized continuous wavelength laser light V;H output from the first half-wavelength plate H1 of the orthogonally polarized continuous wavelength laser light source 100, and reflects vertically polarized light V to output it to the first Mach-Zehnder path (the upper path (|V [symbol] ᵤ where EOM1 is located in FIG. 2), and transmits the horizontally polarized light H to output to the second Mach-Zehnder path (|H [symbol] ₗ). The vertically polarized light V and the horizontally polarized light H split by the first polarization beam splitter automatically satisfy the polarization-path correlation |V [symbol] ᵤ|H [symbol] ₗ.

The first electro-optic modulator EOM1 and the second electro-optic modulator EOM2 inversely convert the polarization bases of vertically polarized light V and horizontally polarized light H on the first Mach-Zehnder path and the second Mach-Zehnder path, respectively:

$${{{{\vert V 〉}_{u} \vert H 〉}_{l} \to \vert H 〉}_{u} \vert V 〉}_{l} .$$

Accordingly, when the switching duty cycle of the first electro-optical modulator EOM1 and the second electro-optical modulator EOM2 is set to 50%, the vertically polarized light passing through the first electro-optical modulator EOM1 continuously progresses on the first Mach-Zehnder path alternating vertically polarized light and horizontally polarized light at the same ratio, i.e., 50:50, and the horizontally polarized light passing through the second electro-optical modulator EOM2 continuously progresses on the second Mach-Zehnder path alternating horizontally polarized light and vertically polarized light at the same ratio, i.e., 50:50. That is, the light incident on the first Mach-Zehnder path and the second Mach-Zehnder path satisfies the vertical-horizontal polarization correlation with the first electro-optical modulator EOM1 and the second electro-optical modulator EOM2 turned off, and satisfies the horizontal-vertical polarization correlation with the first electro-optical modulator EOM1 and the second electro-optical modulator EOM2 turned on, ensuring the randomness of the polarization base in each Mach-Zehnder path.

This is explained in more detail as follows.

When measuring light at an arbitrary time on each of the first Mach-Zehnder path and the second Mach-Zehnder path, the polarization state cannot be specified:

$${{{{{\vert Ψ 〉}_{up} = ( \vert V 〉}_{u} + \vert H 〉}_{u} ) / \sqrt{2} ; {\vert Ψ 〉}_{down} = ( \vert H 〉}_{l} + \vert V 〉}_{l} ) / \sqrt{2} .$$

That is, the traveling polarized light satisfies the polarization base randomness on the first Mach-Zehnder path and the second Mach-Zehnder path, respectively, and for the simultaneous pulse pairs generated by the first electro-optic modulator EOM1 and the second electro-optic modulator EOM2, satisfies the opposite polarizer pair relationship:

$${{{{{\vert Ψ 〉}_{MZI} = ( \vert V 〉}_{u} \vert H 〉}_{l} + \vert H 〉}_{u} \vert V 〉}_{l} ) / \sqrt{2} .$$

Meanwhile, the second half-wave plate H2 rotates the polarized light output from the second electro-optical modulator EOM2 by 90 degrees to reverse the polarization given in the second Mach-Zehnder path.

For example, when the second electro-optical modulator EOM2 is turned on to convert horizontally polarized light into vertically polarized light and output it, the second half-wave plate H2 changes the output vertically polarized light into horizontally polarized light, and when the second electro-optical modulator EOM2 is turned off and the horizontally polarized light is output as horizontally polarized light without conversion, the second half-wave plate H2 changes the output horizontally polarized light into vertically polarized light.

As a result, the final polarization input from the first Mach-Zehnder path and the second Mach-Zehnder path to the second polarization beam splitter PBS2 satisfies the following polarization-path correlation when viewed on simultaneous time scales:

$${{{{{\vert Ψ 〉}_{MZI} = ( \vert V 〉}_{u} \vert V 〉}_{l} + \vert H 〉}_{u} \vert H 〉}_{l} ) / \sqrt{2} .$$

The second polarizing beam splitter PBS2 reflects the vertically polarized light output from the first Mach-Zehnder path and the second half-wave plate H2 and proceeds on the second Mach-Zehnder path, and transmits the horizontally polarized light, thus outputting light on two paths, that is, |V [symbol] ᵤ+|H [symbol] ₗ light on E_{A} path, and |H [symbol] ᵤ+|V [symbol] ₗ light is output on E_{B} path.

In conclusion, the polarization-path correlation Mach-Zehnder interferometer outputs |V [symbol] ᵤ+|H [symbol] ₗ light on the E_{A} path, and outputs |H [symbol] ᵤ+|V [symbol] ₗ light on the E_{B} path.

Therefore, referring to FIG. 3, the light output from the polarization-path correlation Mach-Zehnder interferometer 200 has polarization randomness in both of the E_{A} path and the E_{B} path, the output paths, satisfies vertical-vertical or horizontal-horizontal polarization basis correlation between the E_{A} path and the E_{B} path, and has an exclusive relationship by being separated from the time axis, which is the core principle of quantum information based on particle nature.1

In other words, the light output from the polarization-path correlation Mach-Zehnder interferometer 200 is independent without coherence, and does not satisfy the indistinguishability that is key to quantum coherence.

To solve this problem, a pair of frequency-path correlation Mach-Zehnder interferometers 300 are required.

Each of the pair of frequency-path correlation Mach-Zehnder interferometers 300 includes: a third polarizing beam splitter PBS3 that receives light output from the second polarizing beam splitter PBS2, reflects the vertically polarized light to output it to a third Mach-Zehnder path, and transmits the horizontally polarized light to output it to a fourth Mach-Zehnder path; a first acousto-optic modulator AOM1 located in the third Mach-Zehnder path; a second acousto-optic modulator AOM2 located in the fourth Mach-Zehnder path; and a non-polarizing beam splitter BS that reflects and transmits half of the vertically and horizontally polarized light traveling on the third Mach-Zehnder path and the fourth Mach-Zehnder path and outputs it to two paths.

Preferably, each of the pair of frequency-path correlation Mach-Zehnder interferometers 300 may further include a third mirror M3 that reflects light traveling on the third Mach-Zehnder path and a fourth mirror M4 that reflects light traveling on the fourth Mach-Zehnder path.

In addition, preferably, the fourth Mach-Zehnder path of each of the pair of frequency-path correlation Mach-Zehnder interferometers 300 delays the vertically correlated laser light pulse pairs |V [symbol] ᵤ and |V [symbol] ₗ generated in the state that the first electro-optical modulator EOM1 and the second electro-optical modulator EOM2 are turned off by T_{E} which is the switch duty-on time of the first electro-optical modulator EOM1 and the second electro-optical modulator EOM2, compared to the third Mach-Zehnder path.

In order to generate this time delay T_{E}, the fourth Mach-Zehnder path may have a greater length than the third Mach-Zehnder path. For example, the fourth Mach-Zehnder path may be comprised of an optical fiber that is 30 cm longer than the third Mach-Zehnder path to generate a time delay of 1 ns.

Accordingly, referring to Eₛ and Eᵢ in FIG. 3, the laser light pulse pair |V [symbol] ᵤ and |V [symbol] ₗ having a vertical-vertical correlation are input to the quantum eraser 400 in a temporally matched state with the laser light pulse pair |H [symbol] ᵤ and |H [symbol] ₗ having an exclusive horizontal-horizontal correlation in the time axis while traveling along the third Mach-Zehnder path.

As a result, the pair of frequency-path correlation Mach-Zehnder interferometers 300 secures indistinguishability, which is an essential element in quantum information, and secures coherence (or quantum superposition) between pulse pairs and outputs them to a pair of quantum erasers 400.

However, as a result of ensuring coherence between exclusive pulse pairs due to time delay, four tensor product terms are generated, and these four tensor product terms need to be reduced to two tensor product terms to satisfy quantum characteristics.

To reduce to two tensor product terms, the frequency-path correlation Mach-Zehnder interferometer 300 includes a first acousto-optic modulator and a second acousto-optic modulator.

Each of the pair of frequency-path correlation Mach-Zehnder interferometers 300 generates a frequency-path correlation entangled light pair by the first acousto-optic modulator AOM1 and the second acousto-optic modulator AOM2 while maintaining polarization-path correlation.

The third polarization beam splitter PBS3 reflects vertically polarized light output from the polarization-path correlation Mach-Zehnder interferometer 200 and transmits horizontally polarized light.

More specifically, the third polarization beam splitter PBS3 of one of the pair of frequency-path correlation Mach-Zehnder interferometers 300 transmits |H [symbol] ₗ light and reflects |V [symbol] ᵤ light out of the light |V [symbol] ᵤ+|H [symbol] ₗ output from the polarization-path correlation Mach-Zehnder interferometer 200 to the E_{A} path.

In addition, the third polarizing beam splitter PBS3 of the other one of the pair of frequency-path correlation Mach-Zehnder interferometers 300 transmits |H [symbol] ᵤ light and reflects |V [symbol] ₗ light out of the light |H [symbol] ᵤ+|V [symbol] ₗ output from the polarization-path correlation Mach-Zehnder interferometer 200 to the fa path.

The first acousto-optic modulator AOM1 of one of the pair of frequency-path correlation Mach-Zehnder interferometers 300 modulates |H [symbol] ₗ light input to the E_{A} path and transmitted through the third polarization beam splitter PBS3 by −Δ_{f}, and the second acousto-optic modulator AOM2 frequency modulates |V [symbol] ₗ light input to the E_{A} path and reflected by the third polarization beam splitter PBS3 symmetrically by +Δ_{f}:|H [symbol] ₗ→|H [symbol] ₗ^{-Δ}^{_{f}}; |V [symbol] ᵤ→|V [symbol] ₕ^{+Δ}^{_{f}}.

The first acousto-optic modulator AOM1 of the other of the pair of frequency-path correlation Mach-Zehnder interferometers 300 modulates |H [symbol] ᵤ light input to the E_{B} path and transmitted through the third polarization beam splitter PBS3 by −Δ_{f}, and the second acousto-optic modulator AOM2 frequency modulates |V [symbol] ₗ light input to the E_{B} path and reflected by the third polarization beam splitter PBS3 symmetrically by +Δ_{f}:|H [symbol] ᵤ→|H [symbol] ᵤ^{-Δ}^{_{f}}; |V [symbol] ₗ→|V [symbol] ₗ^{+Δ}^{_{f}}.

The first acousto-optic modulator AOM1 and the second acousto-optic modulator AOM2 of the pair of frequency-path correlation Mach-Zehnder interferometers 300 perform ±Δ_{f} frequency modulation symmetrically and simultaneously in opposite directions, that is, at the laser center frequency f₀, so that the correlated laser light pulse pair passing through the first acousto-optic modulator AOM1 and the second acousto-optic modulator AOM2 additionally satisfies the f₀±Δ_{f} frequency correlation.

Therefore, referring to FIGS. 2 and 3, the output laser light pulse pair of one of the pair of frequency-path correlation Mach-Zehnder interferometers 300 satisfies the horizontal (−Δ_{f})-vertical (+Δ_{f}) correlation, and this symmetrical polarization/frequency-path correlation appears the same in the other one of the pair of frequency-path correlation Mach-Zehnder interferometers 300. However, the generation path of polarization obtained from the polarization-path correlation Mach-Zehnder interferometer is reversed.

The non-polarizing beam splitter BS of one of the pair of frequency-path correlation Mach-Zehnder interferometers 300 receives the light output from the first acousto-optic modulator AOM1 and the second acousto-optic modulator AOM2 and light satisfying the relationship of |Ψ [symbol] ⱼ=(ie^{iφ}^{ⱼ}|H [symbol] ₗ^{-Δ}^{_{f}}+|V [symbol] ᵤ^{+Δ}^{_{f}})/\sqrt{2} is output to Eₛ₁ path, and light satisfying the relationship of |Ψ [symbol] ⱼ=(e^{iφ}^{ⱼ}|H [symbol] ₗ^{-Δ}^{_{f}}+i|V [symbol] ᵤ^{+Δ}^{_{f}})/\sqrt{2} is output to Eₛ₂ path.

In addition, the other non-polarizing beam splitter BS of the pair of frequency-path correlation Mach-Zehnder interferometers 300 receives the light output from the first acousto-optic modulator AOM1 and the second acousto-optic modulator AOM2, and light satisfying the relationship of |Ψ [symbol] ⱼ=(ie^{iφ}^{ⱼ}|H [symbol] ᵤ^{-Δ}^{_{f}}+|V [symbol] ₗ^{+Δ}^{_{f}})/\sqrt{2} is output to Eᵢ₃ is path, and light satisfying the relationship of |Ψ [symbol] ⱼ=(e^{iφ}^{ⱼ}|H [symbol] ᵤ^{-Δ}^{_{f}}+i|V [symbol] ₗ^{+Δ}^{_{f}})/\sqrt{2} is output to Eᵢ₄ path.

Here, φⱼ is the relative phase difference applied to the horizontally polarized light, and j refers to the light pair output at an arbitrary time.

In conclusion, the final output light from each of the pair of frequency-path correlation Mach-Zehnder interferometers satisfies both the polarization-path correlation and the frequency-path correlation.

When heterodyne is detected in the quantum correlation measurement between two different frequency-path correlation Mach-Zehnder interferometers 300, a pair of quantum erasers 400 is required to ensure that only two of the four tensor product terms, i.e., horizontal-horizontal or vertical-vertical polarized light pulse pairs, are detected.

One of the pair of quantum erasers 400 includes a first polarizer P1 on the Eₛ₁ path, a first detector D1 for detecting the light output from the first polarizer P1, a second polarizer P2 on the Eₛ₂ path, and a second detector D2 for detecting the light output from the second polarizer P2.

In addition, the other of the pair of quantum erasers 400 includes another first polarizer P1 on the Eᵢ₃ path, a third detector D3 for detecting the light output from the another first polarizer P1, another second polarizer P2 on the Eᵢ₄ path, and a fourth detector D4 for detecting the light output from the another second polarizer P2.

In each of the pair of quantum erasers 400, the light output from the pair of frequency-path correlation Mach-Zehnder interferometers 300 passes through the first polarizer P1 and the second polarizer P2 to be converted to the same indistinguishable polarization state due to the effect of projections on the 45-degree rotation axis of the polarizers.

The pair of quantum erasers 400 violates the classical causal relationship because the already polarization distinguishable light pairs incident on the polarization-path correlation Mach-Zehnder interferometer 200 are not polarization distinguishable by measurement. Therefore, the output of the pair of quantum erasers 400 shows an interference pattern.

It has recently been experimentally proven that the pair of quantum erasers 400 generates self-interference of single photons, and that single photons and continuous light sources CW produce the same result.

The two output lights of one of the pair of quantum erasers 400 should be in quantum correlation with the two output lights of the other one of the pair of quantum erasers 400, and this is proved in the equations below.

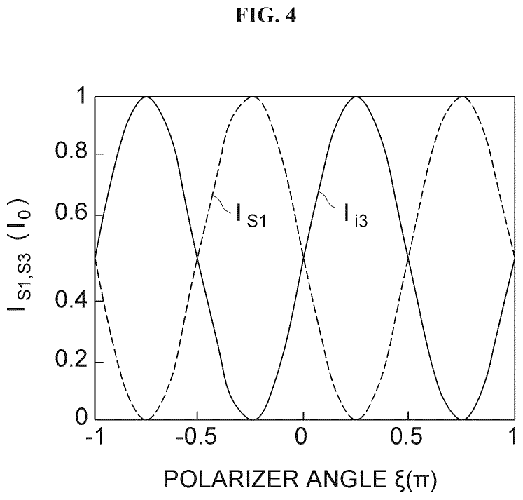

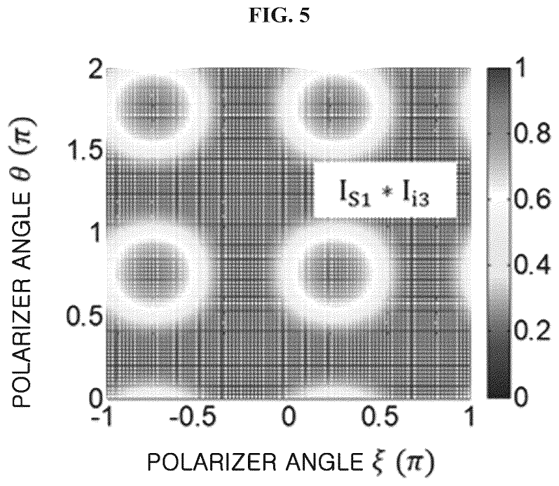

Hereinafter, the process of detecting quantum correlated light pulse pairs by the quantum entanglement generator using a continuous light source according to the present disclosure will be described mathematically. FIG. 4 is a graph showing the results of computational simulation of the final output light of the quantum eraser according to the present disclosure. FIG. 5 shows the results of computational simulation of the local (classical) classical correlation between the final output light of the quantum eraser according to the present disclosure.

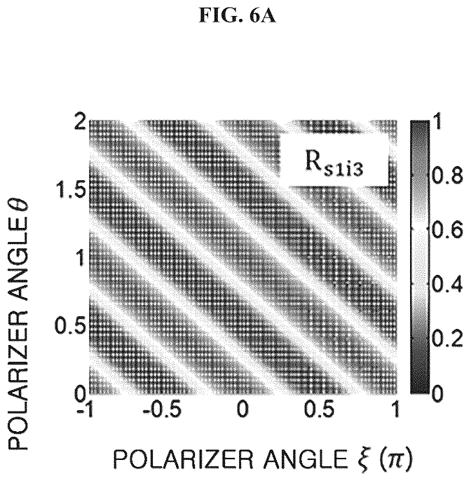

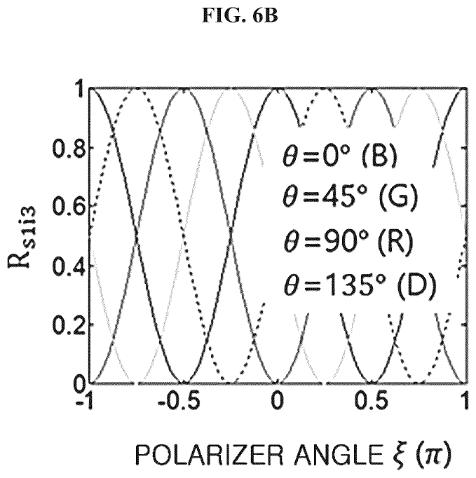

FIG. 6A is a non-local (quantum) quantum correlation computational simulation showing the product of the light output from one of the pair of quantum erasers and the light output from the other of the pair of quantum erasers, and FIG. 6B is a graph showing the intensity of the product of the light output from one of the pair of quantum erasers and the light output from the other of the pair of quantum erasers.

The four output lights output from the pair of frequency-path correlation Mach-Zehnder interferometers 300 are in a distinguishable state, that is, the corresponding Mach-Zehnder paths are separated into vertical/horizontal components, so the output lights cannot create an interference pattern. In the microscopic world, this phenomenon is expressed as orthogonality between quantum operators, and in the macroscopic world of coherence optics, it is expressed as the Fresnel-Arago law.

However, referring to FIG. 4, the polarization of each light pulse passing through the first polarizer P1 and the second polarizer P2 located in the optical path of the pair of quantum erasers 400 is projected in common by the 45-degree rotation angle of the polarizers, making each polarization base indistinguishable from the other, resulting in an interference pattern.

A coincidence detection method is usually used to measure the quantum correlation between the output light of a pair of quantum erasers 400, whereas in the present disclosure “continuous wavelength quantum laser”, a classical correlation measurement method is used, which is the same in that the principle is an AND logic gate of light intensity. As described above in the polarization-path correlation Mach-Zehnder interferometer 200 and the pair of frequency-path correlation Mach-Zehnder interferometers 300, in the polarization/frequency-path correlated light pulse pair, only the horizontal-horizontal or vertical-vertical tensor product term is included in the measurement target by the heterodyne measurement method. For this purpose, only the ac (beating) signal needs to be passed when measuring the classical correlation.

Referring to FIG. 5, the classical correlation is expressed as the product of the output light of a pair of quantum erasers 400. This computational simulation result is simply the product of the output intensities of the quantum erasers, quantum characteristics do not appear.

Referring to FIGS. 6A and 6B, as a result of extracting only the ac signal, the tensor product of the light output from one of the pair of quantum erasers and the light output from the other of the pair of quantum erasers, as shown in Equation 9, establishes quantum superposition between the respective intensities, and ensures an inseparable quantum correlation between the two polarizer variables. A typical quantum correlation as shown in FIGS. 6A and 6B satisfies the violation of Bell's inequality.

Referring again to FIG. 2, the two output lights E_{A} and E_{B} of the polarization-path correlation Mach-Zehnder interferometer 200 are polarization modulated by the first electro-optical modulator EOM1 and the second electro-optic modulator EOM2, which can be expressed as follows:

$${E}_{A} = \frac{{E}_{0}}{2} ( - {\hat{V}}_{u} {e}^{i ψ} + {\hat{H}}_{l} ) \qquad ( Equation 1 )$$

$${E}_{B} = \frac{{E}_{0}}{2} ( {\hat{V}}_{l} {e}^{i ψ} + {\hat{H}}_{u} {e}^{i ψ} ) \qquad ( Equation 2 )$$

Referring to FIG. 2, the output light of each of the pair of frequency-path correlation Mach-Zehnder interferometers 300 is frequency modulated by each of the first acousto-optic modulator AOM1 and the second acousto-optic modulator AOM2, which can be expressed as follows:

$${E}_{s 1} = \frac{{iE}_{0}}{2} ( - {\hat{V}}_{u} {e}^{i φ} sin ξ + {\hat{H}}_{l} cos ξ ) \qquad ( Equation 3 )$$

$${E}_{s 2} = \frac{{E}_{0}}{2} ( {\hat{V}}_{u} {e}^{i φ} sin ξ + {\hat{H}}_{l} cos ξ ) \qquad ( Equation 4 )$$

$${E}_{i 3} = \frac{- {E}_{0}}{2} ( {\hat{V}}_{l} sin θ + {\hat{H}}_{u} {e}^{i φ} cos θ ) \qquad ( Equation 5 )$$

$${E}_{i 4} = \frac{{iE}_{0}}{2} ( - {\hat{V}}_{l} sin θ + {\hat{H}}_{u} {e}^{i φ} cos θ ) \qquad ( Equation 6 )$$

$$where , {φ}^{′} = ψ + ζ ( {T}_{E} τ ) + 2 {Δ}_{f} τ .$$

FIG. 4 shows the intensity of the output light of each of the pair of frequency-path correlation Mach-Zehnder interferometers 300. Therefore, referring to FIG. 4, the average intensity of Equations 3 to 6 is as follows:

$$〈 {I}_{s 1} 〉 = 〈 {I}_{i 4} 〉 = \frac{{I}_{0}}{2} 〈 1 - sin 2 {ξcosφ}^{′} 〉 \qquad ( Equation 7 )$$

$$〈 {I}_{s 2} 〉 = 〈 {I}_{i 3} 〉 = \frac{{I}_{0}}{2} 〈 1 + sin 2 {ξcosφ}^{′} 〉 \qquad ( Equation 8 )$$

Referring to FIG. 4, in Equation 7 and Equation 8, when the phase control of the polarization-path correlation Mach-Zehnder interferometer 200, that is, ψ=0, the intensity of each final output light in FIG. 1 depends only on the rotation angle of the polarizer P.

FIG. 5 corresponds to the product of Equation 7 and Equation 8, and shows the classical correlation between pairs of light pulses output from each of the quantum erasers 400, which is naturally variable separable.

Finally, the quantum correlation between the output light of one of the pair of quantum erasers 400 and the output light of the other of the pair of quantum erasers 400 is expressed by heterodyne simultaneous measurement as follows:

$$〈 {R}_{s 1 i 3} 〉 = 〈 {R}_{s 2 i 4} 〉 = \frac{{I}_{0}^{2}}{16} 〈 ( - {\hat{V}}_{u} {e}^{i φ} sin ξ + {\hat{H}}_{l} cos ξ ) ( {\hat{V}}_{l} sin θ + {\hat{H}}_{u} {e}^{i φ} cos θ ) ( cc ) 〉 = \frac{{I}_{0}^{2}}{16} 〈 ( - {\hat{V}}_{u} {\hat{V}}_{l} sin θsinξ + {\hat{H}}_{u} {\hat{H}}_{l} cos θcosξ ) ( cc ) 〉 = \frac{{I}_{0}^{2}}{16} 〈 {cos}^{2} ( ξ + θ ) 〉 \qquad ( Equation 9 )$$

Equation 9 is expressed as the sum of independent polarizer parameters ξ, θ, and this expression is in a form (inseparability in quantum correlation) that cannot be expressed as the product of two intensities [symbol] Iₛ₁Iᵢ₃ [symbol] , and is therefore a typical expression for non-classical correlations.

FIGS. 6A and 6B show the results of computational simulation for Equation 9, with the maximum size reduced to 1 (normalization). As shown in FIG. 6A, the integrated relational expression for the two polarizer parameters is shown, and unlike the results shown in FIG. 5, it shows a relationship that cannot be expressed as a trigonometric product, i.e., the polarizer variables are not separable.

Meanwhile, referring to FIG. 6B, it shows the relationship between one fixed parameter θ and the other parameter ξ, which is an intensity (photon) product interference pattern shift phenomenon that appears in a typical quantum correlation. In this computational simulation of quantum correlation, it is shown that the Bell inequality parameter S is violated.

The present disclosure relates to a new method and apparatus for achieving the objective of non-classical photon pair generation using conventional lasers by creating a completely new technique that is not possible with each individual approach developed so far in quantum information technology. In addition, the present disclosure derives polarization-path and frequency-path correlations based on quantum coherence between the two paths of linear optics and interferometers based on a typical laser light source, which is impossible with conventional particle-based quantum analysis, and mathematically derives quantum correlations based on the quantum entanglement relationship, that is, the non-classical quantum correlation that appears in ordinary entangled photon pairs, and supports the result by computational simulation, which is the method and apparatus that conclusively shows a violation of the ordinary Bell inequality.

The embodiments of the present disclosure described above may also be implemented in the form of a recording medium containing instructions executable by a computer, such as program modules executed by a computer. The recording medium includes a computer-readable medium, which may be any available medium that can be accessed by a computer and includes all of the volatile and non-volatile mediums, and detachable and non-detachable mediums. Further, the computer-readable medium includes a computer storage medium, and the computer storage medium includes all of the volatile and non-volatile mediums, and detachable and non-detachable mediums implemented in any method or technology for storage of information such as computer-readable instructions, data structures, program modules, or other data.

The foregoing description of the present disclosure is for illustrative purposes, and those having ordinary skill in the art to which the present disclosure pertains will understand that the present disclosure can be easily modified into other specific forms without changing the technical idea or essential features of the present disclosure. Therefore, the embodiments described above should be understood in all respects as illustrative and not restrictive. For example, each component described in a single form may be implemented in a distributed manner, and similarly, components described as distributed may also be implemented in a combined form.

The scope of the present disclosure is defined by the claims described below rather than the detailed description above, and all modifications or variations derived from the meaning and scope of the claims and their equivalent concepts should be construed as being included in the scope of the present disclosure.

### DESCRIPTION OF REFERENCE SYMBOLS

L: continuous-wavelength laser light source
H: half-wave plate
PBS: polarizing beam splitter
AOM: acousto-optic modulator
EOM: electro-optical modulator
AC: AOM controller
BC: EOM controller

What is claimed is:

1. A continuous-wavelength quantum entanglement laser generator comprising:
an orthogonally polarized continuous wavelength laser light source;
a polarization-path correlation Mach-Zehnder interferometer for controlling the polarization base of the orthogonally polarized continuous wavelength laser light source;
a pair of frequency-path correlation Mach-Zehnder interferometers for generating a frequency-path correlation entangled light pair using two outputs of the polarization-path correlation Mach-Zehnder interferometer as input sources; and
a pair of quantum erasers for converting frequency-distinguishable light output from the pair of frequency-path correlation Mach-Zehnder interferometers into indistinguishable entangled light.

2. The continuous-wavelength quantum entanglement laser generator of claim 1, further comprising a Mach-Zehnder phase control unit that controls a phase of the polarization-path correlation Mach-Zehnder interferometer.

3. The continuous-wavelength quantum entanglement laser generator of claim 1, wherein the orthogonally polarized continuous-wavelength laser light source further includes a first half-wave plate that rotates a vertically or horizontally polarized continuous-wavelength laser at 22.5 degrees.

4. The continuous-wavelength quantum entanglement laser generator of claim 1, wherein the polarization-path correlation Mach-Zehnder interferometer includes: a first polarizing beam splitter that receives an orthogonally polarized continuous-wavelength laser light, reflects the orthogonally polarized continuous-wavelength laser as vertically polarized light to be output to a first Mach-Zehnder path, and transmits the orthogonally polarized continuous-wavelength laser as horizontally polarized light to be output to a second Mach-Zehnder path; a first electro-optical modulator located in the first Mach-Zehnder path; a second electro-optical modulator located in the second Mach-Zehnder path; a second half-wave plate that rotates light output from the second electro-optical modulator by 45 degrees; and a second polarizing beam splitter that reflects a portion of each vertically or horizontally polarized light traveling on the first Mach-Zehnder path and output from the second half-wave plate and traveling on the second Mach-Zehnder path and transmits the remaining portion to be output to two paths.

5. The continuous-wavelength quantum entanglement laser generator of claim 4, wherein the polarization-path correlation Mach-Zehnder interferometer further includes a first mirror that reflects light traveling on the first Mach-Zehnder path and a second mirror that reflects light traveling on the second Mach-Zehnder path.

6. The continuous-wavelength quantum entanglement laser generator of claim 4, wherein each of the pair of frequency-path correlation Mach-Zehnder interferometers includes: a third polarizing beam splitter that receives light output from the second polarizing beam splitter, reflects the vertically polarized light to be output to a third Mach-Zehnder path, and transmits the horizontally polarized light to be output to a fourth Mach-Zehnder path; a first acousto-optic modulator located in the third Mach-Zehnder path; a second acousto-optic modulator located in the fourth Mach-Zehnder path; and a non-polarizing beam splitter that reflects and transmits half of the vertically and horizontally polarized light traveling on the third Mach-Zehnder path and the fourth Mach-Zehnder path to be output to two paths.

7. The quantum entanglement generator of claim 6, wherein each of the pair of frequency-path correlation Mach-Zehnder interferometers further includes a third mirror that reflects light traveling on the third Mach-Zehnder path and a fourth mirror that reflects light traveling on the fourth Mach-Zehnder path.

8. The continuous-wavelength quantum entanglement laser generator of claim 6, wherein the fourth Mach-Zehnder path has a greater length than the third Mach-Zehnder path.

9. The continuous-wavelength quantum entanglement laser generator of claim 1, wherein one of the pair of quantum erasers includes a first polarizer on Eₛ₁ path, a first detector for detecting light output from the first polarizer, a second polarizer on Eₛ₂ path, and a second detector for detecting light output from the second polarizer.

10. The continuous-wavelength quantum entanglement laser generator of claim 9, wherein the other one of the pair of quantum erasers includes another first polarizer on Eᵢ₃ path, a third detector for detecting light output from the another first polarizer, another second polarizer on Eᵢ₄ path, and a fourth detector for detecting light output from the another second polarizer.
